(19) United States
(12) Patent Application Publication
(10) Pub. No.: US 2026/0302201 A1
(43) Pub. Date: Oct. 1, 2026

(54) CATHODE ACTIVE MATERIAL HAVING SPINEL STRUCTURE

(71) Applicant: Topsoe Battery Materials A/S, Kgs. Lyngby (DK)

(72) Inventors: Jonathan HØJBERG, Kgs. Lyngby (DK); Christian Fink ELKJÆR, Kgs. Lyngby (DK); Jakob Weiland HØJ, Kgs. Lyngby (DK); Søren DAHL, Kgs. Lyngby (DK)

(73) Assignee: Topsoe Battery Materials A/S, Kgs. Lyngby (DK)

(21) Appl. No.: 19/475,880

(22) PCT Filed: Apr. 19, 2024
(86) PCT No.: PCT/EP2024/060682

§ 371 Date: Oct. 16, 2025

(30) Foreign Application Priority Data
Apr. 20, 2023 (EP) 23168969.6

(51) Int. Cl. H01M 4/505; C01G 53/54; H01M 4/36

(52) U.S. Cl. CPC H01M 4/505; C01G 53/54; H01M 4/364; C01P 2002/32; C01P 2004/03; C01P 2004/61; C01P 2004/62; C01P 2006/40

(57) ABSTRACT

The present invention relates to a cathode active material comprising: (a) first crystal particles, wherein the first crystal particles have a spinel structure and are of the formula LiₓNi_{y}Mn_{3-x-y-z}D_{z}O₄, wherein 0.95≤x≤1.05; and 0.45≤y≤0.50, and 0≤z≤0.20, and wherein D is a dopant selected from B, N, F, Mg, Al, Nb, Si, P, La, S, Ca, Ti, Cr, Fe, Co, Cu, Zn, Zr, Mo, Sn, W and mixtures thereof, and the first crystal particles have a particle size of no greater than 3 μm measured as the arithmetic mean value of the minimum Feret diameter of the particles measured using scanning electron microscopy, (b) second crystal particles, wherein the second crystal particles comprise material having a spinel structure and which is of the formula Li_{x′}Ni_{y′}Mn_{3-x′-y′-z′}D′_{z′}O₄, wherein: 0.95≤x′≤1.05; 0.43≤y′<0.47, and 0≤z′≤0.20, and wherein D′ is a dopant selected from B, N, F, Mg, Al, Nb, Si, P, La, S, Ca, Ti, Cr, Fe, Co, Cu, Zn, Zr, Mo, Sn, W and mixtures thereof, and the second crystal particles have an average particle size of at least 3 times that of the average particle size of the first crystal particles, measured as the arithmetic mean value of the minimum Feret diameter of the particles measured using scanning electron microscopy.

### FIELD OF THE INVENTION

The present invention relates to a cathode active material for use in lithium batteries.

### BACKGROUND OF THE INVENTION

Developing high energy density rechargeable battery materials have become a major research topic due to their broad applications in electric vehicles, portable electronics and grid-scale energy storage. Since their first commercialization in the early 1990s, Li-ion batteries (LIBs) present many advantages with respect to other commercial battery technologies. In particular, their higher specific energy and specific power make LIBs the best candidate for electric mobile transport application.

LNMO, or lithium nickel manganese oxide, is a cathode material that is gaining attention in the battery industry due to its promising electrochemical performance and relatively low cost compared to other high-energy-density cathode materials, such as NCA and LCO.

LNMO has a similar crystal structure to LMO, but with the addition of nickel, which increases its energy density and improves its thermal stability. LNMO also has a lower toxicity than other nickel-containing cathode materials, making it a more environmentally friendly option.

One of the main advantages of LNMO is its high-capacity retention and cycle stability, which means that it can maintain a high energy capacity over many charging and discharging cycles. This makes it a promising candidate for use in electric vehicle batteries, where long cycle life is critical.

Lithium positive electrode active materials may be characterized by the formula: LiₓNi_{y}Mn_{2-y}O_{4-δ} wherein 0.9≤x≤1.1, 0.4≤y≤0.5 and 0≤δ≤0.1. Such materials may be used for e.g.: portable equipment (U.S. Pat. No. 8,404,381); electric vehicles, energy storage systems, auxiliary power units and uninterruptible power supplies. Lithium positive electrode active materials are seen as a prospective successor to current lithium secondary battery cathode materials such as: LiCoO₂, and LiMn₂O₄.

Lithium positive electrode active materials may be prepared from precursors obtained by a co-precipitation process. The precursors and product are spherical due to the co-precipitation process. Electrochimica Acta (2014), pp 290-296 discloses a material prepared from precursors obtained by a co-precipitation process followed by sequential sintering (heat treatment) at 500° C., followed by 800° C. The product obtained is highly crystalline and has a spinel structure after the first heat treatment step (500° C.). A uniform morphology, tap density of 2.03 g cm⁻³ and uniform secondary particle size of 5.6 μm of the product is observed. Electrochimica Acta (2004) pp 939-948 states that a uniform distribution of spherical particles exhibits a higher tap density than irregular particles due to their greater fluidity and ease of packing.

Lithium positive electrode active materials may also be prepared from precursors obtained by mechanically mixing starting materials to form a homogenous mixture, as disclosed in U.S. Pat. No. 8,404,381. The precursor is heated at 600° C., annealed between 70° and 950° C., and cooled in a medium containing oxygen. It is disclosed that the 600° C. heat treatment step is required in order to ensure that the lithium is well incorporated into the mixed nickel and manganese oxide precursor. It is also disclosed that the annealing step is generally at a temperature greater than 800° C. in order to cause a loss of oxygen while creating the desired spinel morphology. It is further disclosed that subsequent cooling in an oxygen containing medium enables a partial return of oxygen. U.S. Pat. No. 7,754,384 is silent with regard to the tap density of the material. It is also disclosed that 1 to 5 mole percent excess of lithium is used to prepare the precursor.

U.S. Pat. No. 7,754,384 also teaches a material with the formula LiNi_{0.4}Mn_{1.6}O_{4-δ}, wherein δ>0. It is disclosed that a material with the given formula, i.e. a low amount of Ni compared to Mn, has a high cycling stability.

J. Electrochem. Soc. (1997) 144, pp 205-213, also discloses the preparation of spinel LiNi_{0.5}Mn_{1.5}O₄ from a precursor prepared from mechanically mixing starting materials to obtain a homogenous mixture. The precursor is heated three times in air at 750° C. and once at 800° C. It is disclosed that LiNi_{0.5}Mn_{1.5}O₄ loses oxygen and disproportionates when heated above 650° C.; however, the LiNi_{0.5}Mn_{1.5}O₄ stoichiometry is regained by slow cooling rates in an oxygen containing atmosphere.

WO2020/127543 discloses a lithium positive electrode active material for a high voltage secondary battery, where the lithium positive electrode active material comprises at least 94 wt % spinel, said spinel having a net chemical composition of LiₓNi_{y}Mn_{2-y}O₄, where 0.95≤x≤1.05 and 0.43≤y≤0.47. The lithium positive electrode active material is made up of spherical particles. The material has a high capacity, high voltage against Li/Li⁺ reference and low degradation.

It is desirable to provide a cathode active material having improved volumetric energy density and/or higher voltage and/or a high energy density. It is desirable to provide a cathode active material having improved performance over multiple charge and discharge cycles.

### SUMMARY OF THE INVENTION

In one aspect there is provided a cathode active material comprising:
(a) first crystal particles, wherein the first crystal particles have a spinel structure and are of the formula LiₓNi_{y}Mn_{3-x-y-z}D_{z}O₄, wherein 0.9≤x≤1.05; and 0.45≤y≤0.50, and 0≤z≤0.20, and wherein D is a dopant selected from B, N, F, Mg, Al, Nb, Si, P, La, S, Ca, Ti, Cr, Fe, Co, Cu, Zn, Zr, Mo, Sn, W and mixtures thereof, and the first crystal particles have a particle size of no greater than 3 μm measured as the arithmetic mean value of the minimum Feret diameter of the particles measured using scanning electron microscopy,
(b) second crystal particles, wherein the second crystal particles comprise material having a spinel structure and which is of the formula Li_{x′}Ni_{y′}Mn_{3-x′-y′-z′}D′_{z′}O₄, wherein: 0.95≤x′≤1.05; 0.43≤y′<0.47, and 0≤z′≤0.20, and wherein D′ is a dopant selected from B, N, F, Mg, Al, Nb, Si, P, La, S, Ca, Ti, Cr, Fe, Co, Cu, Zn, Zr, Mo, Sn, W and mixtures thereof, and the second crystal particles have an average particle size of at least 3 times that of the average particle size of the first crystal particles, measured as the arithmetic mean value of the minimum Feret diameter of the particles measured using scanning electron microscopy, wherein y>y′.

The materials of the present invention may be prepared by two distinct processes which form the first crystal particles and the second crystal particles, and the first crystal particles and the second crystal particles may then be combined.

In another aspect the present invention provides a process for the preparation of a cathode active material as described herein, comprising:
A. the preparation of one or more single crystals of the first component, comprising the steps of:
(i) providing one or more lithium precursor compounds and one or more transition metal precursor compounds,
(ii) contacting and milling the precursor compounds to form a milled mixture;
(iii) calcining the milled mixture to provide a calcined mixture;
B. the preparation of the second crystal particles of the positive electrode active material comprising the steps of:
(i) providing one or more transition metal compounds,
(ii) precipitating the transition metals to form a precipitate, and washing the precipitate to form a first precursor mixture;
(iii) contacting the first precursor mixture with a one or more lithium precursor compounds to form a second precursor mixture, and
(iv) calcining the second precursor mixture.′
C. combining the products obtained in A and B.

It has been surprising found that the cathode active material of the present invention, due to the mix of the above mentioned materials, with different Ni-content, enables a high Ni-content in the cathode without sacrificing electrochemical stability. As a consequence, an improved packing density and higher average voltage at the same time, which leads to higher energy density without compromising other properties of the positive electrode active material

In addition, it has been also found that the present materials have a higher stability compared to prior cathode active materials, and in particular over cathode active materials containing only “polycrystalline material” such as those disclosed in WO2020/127543. Indeed, in some aspects it has been found that the cathode active material of the present invention has a stability similar to that of single crystal materials. The cathode active material of the present invention also provides improvement with respect to lower cost and/or the creation of less waste water during their production.

### BRIEF DESCRIPTION OF THE DRAWINGS

FIG. 1. SEM image of Small-Ni435 sample of Example 1.

FIG. 2. SEM image of Large-Ni435 sample of Example 3.

FIG. 3: SEM image of sample Small-Ni435 after embedding in epoxy and polishing to a flat surface.

FIG. 4: SEM image of Cross section of electrode made from 50:50 mix og Small-Ni435 and Large-Ni435.

FIG. 5: Pressed density of the materials Small-Ni435 (light grey symbols), Large-Ni435 (black symbols), and a 50:50 mix of Large-Ni435 and Small-Ni435 as function of pressing pressure.

FIG. 6 LNMO-Li half-cell with individual materials. Voltage curve recorded at 0.1 C charge and 0.1 C discharge.

FIG. 7: LNMO-Li half-cell with individual materials. Development in discharge capacity at 23° C. recorded with 0.5 C charge and 1 C discharge.

FIG. 8: LNMO-Li half-cell with mixed materials. Voltage curve recorded at 0.1 C charge and 0.1 C discharge.

FIG. 9: LNMO-Li half-cell with mixed materials. Development in discharge capacity at 23° C. recorded with 0.5 C charge and 1 C discharge.

FIG. 10: LNMO-LTO full cell. Voltage curve recorded at 0.1 C charge and 0.1 C discharge.

FIG. 11: LNMO-LTO full cell. Development in discharge capacity at 23° C. during cycling with 1 C charge and 1 C discharge. Reference cycles shown recorded at 0.1 C charge and 0.1 C discharge. Capacity loss corresponds to 1.4% per 100 cycles for 1.7V-3.4 V and 1.1% for 2.8V-3.4V.

FIG. 12: Degradation as function of Ni-content in the spinel for small and large LNMO cathode active material.

FIG. 13: Discharge and charge voltage curves of LNMO-Li cell as a function of capacity.

FIG. 14: Correspondence between 4V plateau determined electrochemically and lattice parameter, a, determined by X-ray diffraction.

FIG. 15: Correspondence between nickel content in the spinel determined electrochemically and lattice parameter, a, determined by X-ray diffraction.

### DETAILED DESCRIPTION OF THE INVENTION

As discussed herein, there is provided a cathode active material comprising: (a) first crystal particles, wherein the first crystal particles have a spinel structure and are of the formula LiₓNi_{y}Mn_{3-x-y-z}D_{z}O₄, wherein 0.9≤x≤1.05; and 0.45≤y≤0.50, and 0≤z≤0.20, and wherein D is a dopant selected from B, N, F, Mg, Al, Nb, Si, P, La, S, Ca, Ti, Cr, Fe, Co, Cu, Zn, Zr, Mo, Sn, W and mixtures thereof, and the first crystal particles have a particle size of no greater than 3 μm measured as the arithmetic mean value of the minimum Feret diameter of the particles measured using scanning electron microscopy,
(b) second crystal particles, wherein the second crystal particles comprise material having a spinel structure and which is of the formula Liₓ Ni_{y} Mn_{3′-x′-y′-z′}D′_{z′}O₄, wherein: 0.95≤x′≤1.05; 0.43≤y′<0.47, and 0≤z′≤0.20, and wherein D′ is a dopant selected from B, N, F, Mg, Al, Nb, Si, P, La, S, Ca, Ti, Cr, Fe, Co, Cu, Zn, Zr, Mo, Sn, W and mixtures thereof, and the second crystal particles have an average particle size of at least 3 times that of the average particle size of the first crystal particles, measured as the arithmetic mean value of the minimum Feret diameter of the particles measured using scanning electron microscopy, wherein y>y′.

We have found that by providing this mix of materials we are able to provide a positive electrode active material having improved packing density and higher average voltage at the same time which leads to higher energy density without compromising other properties of the positive electrode active material.

As set out herein, the positive electrode active material comprises particles formed from one or more single crystals of the first crystal particles that have a particle size of no greater than 3 μm measured as the arithmetic mean value of the minimum Feret diameter of the particles measured using scanning electron microscopy.

As will be understood by one skilled in the art, the Feret diameter is the distance between two parallel lines placed opposite each other as tangents on the contour of the particle. The minimum Feret is the smallest distance between two such tangents and may be viewed as the minimum sieve size, this particular particle may go through. e.g. for a rectangular shaped particle, the minimum Feret diameter corresponds to the shortest side, and for a circle the minimum Feret diameter corresponds to the diameter of the circle.

The Feret diameter of a particle is well understood by one skilled in the art. Feret diameter is used in the analysis of particle size and its distribution and has been common in scientific literature since the 1970s. The Feret diameter is a measure of an object size defined as the distance between the two parallel planes restricting the object perpendicular to that direction. It is therefore also called the caliper diameter, referring to the measurement of the object size with a caliper.

The first crystal particles or the second crystal particles may be evaluated to determine the Feret diameter by scanning electron microscopy (SEM). For example, to prepare the material for such a measurement, it is embedded in epoxy and polished to a flat surface, in order to image cross sections of the individual particles comprising the sample. Images obtained in this way are then analyzed in order to measure the size and shape of the particles. The minimum Feret diameter is the smallest distance between two such tangents and may be viewed as the minimum sieve size, this particular particle may go through. e.g. for a rectangular shaped particle, the minimum Feret diameter corresponds to the shortest side, and for a circle the minimum Feret diameter corresponds to the diameter of the circle.

The size of the irregular shaped particle may also be quantified with reference to the diameter of a circle of equal projected area. For a particle with projected area A, the circle of equal area thus has a diameter d=2*√(A/(2*π)).

The Feret diameter of particles may be determined in accordance with the following method. Samples are prepared for scanning electron microscopy (SEM) by embedding the material in epoxy and polishing to a flat surface. SEM images are acquired on a Zeiss GeminiSEM 500, equipped with a field emission gun (FEG), using an acceleration voltage of 10 kV and the energy selective backscattered (ESB) detector, which is of the backscatter electron detector type. The pixel size is 0.01 μm/pixel. A total number of 25 images are acquired and stitched to a high resolution image of 4930 pixels by 3697 pixels corresponding to an image area of 48 μm*36 μm. The image is analysed according to the procedure below, detecting and analysing a total number of 663 particles. Images are analysed using the software ImageJ (https://imagej.nih.gov). The procedure is the following:
Thresholding and segmentation using “Otsu's algorithm”
Apply the binary process, “Fill holes”
Apply the binary process, “Erode” 8 times
Apply the binary process, “Dilate” 6 times.
Use “Analyze particles” with no size restriction

Fill holes is used to fill possible holes inside particles. The Erode then dilate step is used to remove possible noise and ensure that close laying particle are separated.

“Spinel” means a crystal lattice where oxygen is arranged in a slightly distorted cubic close-packed lattice that may be slightly distorted and cations occupying interstitial octahedral and tetrahedral sites in the lattice. Oxygen and the octahedrally coordinated cations form a framework structure with a 3-dimensional channel system which occupy the tetrahedrally coordinated cations. The ratio between tetrahedrally coordinated and octahedrally coordinated cations is approximately 1:2, and the cation to oxygen ratio is approximately 3:4 for spinel type structures. Cations in the octahedral site can consist of a single element or a mixture of different elements. If a mixture of different types of octahedrally coordinated cations by themselves form a three-dimensional periodic lattice, then the spinel is called an ordered spinel. If the cations are more randomly distributed, then the spinel is called a disordered spinel. Examples of an ordered and a disordered spinel, as described in the P4332 and Fd-3m space groups respectively, are described in Adv. Mater. (2012) 24, pp 2109-2116.

The phase composition of a cathode active material may be determined based on X-ray diffraction patterns acquired using a Phillips PW1800 instrument system in θ-2θ geometry working in Bragg-Brentano mode using Cu Kα radiation (λ=1.541 Å). The observed data needs to be corrected for experimental parameters contributing to shifts in the observed data. This is achieved using the full profile fundamental parameter approach as implemented in the TOPAS software from Bruker. The phase composition as determined from Rietveld analysis is given in wt % with a typical uncertainty of 1-2 percentage points, and represents the relative composition of all crystalline phases. Any amorphous phases are thus not included in the phase composition.

For ease of reference, these and further aspects of the present invention are now discussed under appropriate section headings. However, the teachings under each section are not necessarily limited to each particular section.

### First Crystal Particles—Small-LNMO

The first crystal particles of the present invention have a spinel structure and are of the formula LiₓNi_{y}Mn_{3-x-y-z}D_{z}O₄, wherein 0.9≤x≤1.05; and 0.45≤y≤0.50, and 0≤z≤0.20. D is a dopant selected from B, N, F, Mg, Al, Nb, Si, P, La, S, Ca, Ti, Cr, Fe, Co, Cu, Zn, Zr, Mo, Sn, W and mixtures thereof. The first crystal particles have a particle size of no greater than 3 μm measured as the arithmetic mean value of the minimum Feret diameter of the particles measured using scanning electron microscopy. The first crystal particles may be ordered (space group P4332) or disordered.

In one aspect the first crystal particles have a particle size of no greater than 2.5 μm measured as the arithmetic mean value of the minimum Feret diameter of the particles measured using scanning electron microscopy, such as no greater than 2 μm, such as no greater than 1.8 μm, such as no greater than 1.6 μm, such as no greater than 1.4 μm, such as no greater than 1.2 μm, such as no greater than 1 μm, such as no greater than 0.8 μm.

In one aspect the first crystal particles have a particle size of at least 0.1 μm measured as the arithmetic mean value of the minimum Feret diameter of the particles measured using scanning electron microscopy, such as at least 0.2 μm, such as at least 0.3 μm, such as at least 0.4 μm, such as at least 0.5 μm, such at least 0.6 μm, such as at least 0.7 μm.

In one aspect the first crystal particles have a particle size of at least 0.1 to 2.5 μm measured as the arithmetic mean value of the minimum Feret diameter of the particles measured using scanning electron microscopy, such as from 0.1 to 2 μm, such as from 0.1 to 1.8 μm, such as from 0.1 to 1.6 μm, such as from 0.1 to 1.4 μm, such as from 0.1 to 1.2 μm, such as from 0.1 to 1 μm, such as from 0.1 to 0.8 μm.

In one aspect the first crystal particles have a particle size of at least 0.2 to 2.5 μm measured as the arithmetic mean value of the minimum Feret diameter of the particles measured using scanning electron microscopy, such as from 0.3 to 2.5 μm, such as from 0.4 to 2.5 μm, such as from 0.5 to 2.5 μm, such as from 0.6 to 2.5 μm, such as from 0.7 to 2.5 μm.

As discussed herein, the size of the irregular shaped particle may also be quantified with reference to the diameter of a circle of equal projected area. For a particle with projected area A, the circle of equal area thus has a diameter d=2*√(A/(2*π)). In one aspect the cathode active material comprises first crystal particles, wherein the average equivalent circle diameter of the particles measured using scanning electron microscopy is no greater than 3 μm. In one aspect the average equivalent circle diameter of the particles measured using scanning electron microscopy is no greater than 2.5 μm, such as no greater than 2 μm, such as no greater than 1.8 μm, such as no greater than 1.6 μm, such as no greater than 1.4 μm, such as no greater than 1.2 μm, such as no greater than 1 μm, such as no greater than 0.9 μm.

In one aspect the average equivalent circle diameter of the first crystal particles measured using scanning electron microscopy is at least 0.1 μm, such as at least 0.2 μm, such as at least 0.3 μm, such as at least 0.4 μm, such as at least 0.5 μm, such at least 0.6 μm, such as at least 0.7 μm.

In one aspect the average equivalent circle diameter of the first crystal particles measured using scanning electron microscopy is from 0.1 to 2.5 μm, such as from 0.1 to 2 μm, such as from 0.1 to 1.8 μm, such as from 0.1 to 1.6 μm, such as from 0.1 to 1.4 μm, such as from 0.1 to 1.2 μm, such as from 0.1 to 1 μm, such as from 0.1 to 0.9 μm.

In one aspect the average equivalent circle diameter of the first crystal particles measured using scanning electron microscopy is 0.2 to 2.5 μm, such as from 0.3 to 2.5 μm, such as from 0.4 to 2.5 μm, such as from 0.5 to 2.5 μm, such as from 0.6 to 2.5 μm, such as from 0.7 to 2.5 μm.

In the formula LiₓNi_{y}Mn_{3-x-y-z}D_{z}O₄, x is from 0.95 to 1.05. In one aspect, x is from 0.95 to 1.04, such as from 0.95 to 1.03, such as from 0.95 to 1.02, such as from 0.95 to 1.01, such as from 0.95 to 1. In one aspect, x is from 0.96 to 1.05, such as from 0.97 to 1.05, such as from 0.98 to 1.05, such as from 0.99 to 1.05, such as from 1 to 1.05. In one aspect, x is from 0.96 to 1.04, such as from 0.97 to 1.03, such as from 0.98 to 1.02, such as from 0.99 to 1.01, such as from 0.97 to 1.02, such as from 0.97 to 1.01, such as from 0.97 to 1, such as 1.

In the formula LiₓNi_{y}Mn_{3-x-y-z}D_{z}O₄, y is from 0.45 to 0.50. In one aspect, y is from 0.46 to 0.50, such as from 0.47 to 0.50, such as from 0.48 to 0.50, such as from 0.49 to 0.50, such as 0.50. In one aspect, y is from 0.45 to 0.49, such as from 0.45 to 0.48, such as from 0.45 to 0.47, such as from 0.45 to 0.46, such as 0.45.

In the formula LiₓNi_{y}Mn_{3-x-y-z}D_{z}O₄, z is from 0 to 0.20. In one aspect, z is from 0 to 0.18, such as from 0 to 0.16, such as from 0 to 0.15, such as from 0 to 0.14, such as from 0 to 0.12, such as from 0 to 0.1, such as from 0 to 0.08, such as from 0 to 0.06, such as from 0 to 0.05, such as from 0 to 0.04, such as from 0 to 0.03, such as from 0 to 0.02, such as from 0 to 0.01, such as 0.

D is a dopant and it is clear that when z is 0, D is not present. D may be a dopant selected from B, N, F, Mg, Al, Nb, Si, P, La, S, Ca, Ti, Cr, Fe, Co, Cu, Zn, Zr, Mo, Sn, W and mixtures thereof. In one aspect, D is selected from the group consisting of B, Mg, Al, Nb, Si, P, La, S, Ti, Fe, Co, Cu, Zn, Zr, Mo, Sn, W and mixtures thereof.

In one aspect, the first crystal particles are single crystal particles. As noted herein, the first crystal particles of the present invention have a spinel structure and are of the formula LiₓNi_{y}Mn_{3-x-y-z}D_{z}O₄. It will be appreciated by one skilled in the art that crystal particles having a spinel structure will be predominantly of a spinel structure but that other non-spinel structure material may also be present in the crystal. In one aspect the first crystal particles comprise material having a spinel structure and which is of the formula Li_{x′}Ni_{y′}Mn_{3-x′-y′-z′}D′_{z′}O₄, in an amount of at least 94 wt. %, such as in an amount of at least 96 wt. %, such as in an amount of at least 98 wt. %, such as in an amount of at least 99 wt. %, such as in an amount of at least 99.5 wt. %, such as in an amount of at least 99.9 wt. %, such as in an amount of at least 99.99 wt. %, based on the weight of the second crystal particles.

### Second Crystal Particles Large-LNMO

The second crystal particles of the present invention comprise material having a spinel structure and are of the formula Li_{x′}Ni_{y′}Mn_{3-x′-y′-z′}D′_{z′}O₄, wherein: 0.95≤x′≤1.05; 0.43≤y′<0.47, and 0≤z′≤0.20. D is a dopant selected from B, N, F, Mg, Al, Nb, Si, P, La, S, Ca, Ti, Cr, Fe, Co, Cu, Zn, Zr, Mo, Sn, W and mixtures thereof. The second crystal particles may have a disordered (space group Fd-3m).

In one aspect, the second crystal particles are formed from agglomerated single crystals. In one aspect, the second crystal particles are polycrystalline secondary particles.

The secondary particles may be of any suitable size provided that the second crystal particles have an average particle size of at least 3 times that of the average particle size of the first crystal particles. In one aspect, the one or more secondary particles have an average particle diameter (D50) of less than 50 μm, such as less than 45 μm, such as less than 40 μm, such as less than 35 μm, such as less than 30 μm, such as less than 25 μm, such as less than 20 μm, such as less than 15 μm, such as less than 10 μm.

In one aspect, the one or more secondary particles have an average particle diameter (D50) of at least 1 μm, such as at least 2 μm, such as at least 3 μm, such as at least 4 μm, such as at least 5 μm, such as at least 10 μm.

In one aspect, the one or more secondary particles have an average particle diameter (D50) of from 4 to 50 μm, such as from 4 to 45 μm, such as from 4 to 40 μm, such as from 4 to 35 μm, such as from 4 to 30 μm, such as from 4 to 25 μm, such as from 4 to 20 μm, such as from 4 to 15 μm, such as from 4 to 10 μm.

One way to quantify the size of particles is to plot the entire particle size distribution, i.e. the volume fraction of particles with a certain size as a function of the particle size. In such a distribution, D10 is defined as the particle size where 10% of the population lies below the value of D10, D50 is de-fined as the particle size where 50% of the population lies below the value of D50 (i.e. the median), and D90 is defined as the particle size where 90% of the population lies below the value of D90. Commonly used methods for determining particle size distributions include laser diffraction measurements and scanning electron microscopy measurements, coupled with image analysis. The particle size distribution values D50 are defined and measured as described in Jillavenkatesa A, Dapkunas S J, Lin-Sien Lum: Particle Size Characteri-zation, NIST (National Institute of Standards and Tech-nology) Special Publication 960-1, 2001.

In the formula Li_{x′}Ni_{y′}Mn_{3-x′-y′-z′}D′_{z′}O₄, x is from 0.95 to 1.05. In one aspect, x′ is from 0.95 to 1.04, such as from 0.95 to 1.03, such as from 0.95 to 1.02, such as from 0.95 to 1.01, such as from 0.95 to 1. In one aspect, x′ is from 0.96 to 1.05, such as from 0.97 to 1.05, such as from 0.98 to 1.05, such as from 0.99 to 1.05, such as from 1 to 1.05. In one aspect, x′ is from 0.96 to 1.04, such as from 0.97 to 1.03, such as from 0.98 to 1.02, such as from 0.99 to 1.01, such as from 0.97 to 1.02, such as from 0.97 to 1.01, such as from 0.97 to 1, such as 1.

In the formula Li_{x′}Ni_{y′}Mn_{3′-x′-y′-z′}D′_{z′}O₄, y′ is from 0.43 to 0.47. In one aspect, y′ is from 0.44 to 0.47, such as from 0.45 to 0.47 such as from 0.46 to 0.47, such as from 0.45 to 0.46, such as 0.45. In one aspect, y′ is from 0.43 to 0.46, such as from 0.43 to 0.45, such as from 0.43 to 0.44.

In the formula Li_{x′}Ni_{y′}Mn_{3-x′-y′-z′}D′_{z′}O₄, z′ is from 0 to 0.20. In one aspect, z′ is from 0 to 0.18, such as from 0 to 0.16, such as from 0 to 0.15, such as from 0 to 0.14, such as from 0 to 0.12, such as from 0 to 0.1, such as from 0 to 0.08, such as from 0 to 0.06, such as from 0 to 0.05, such as from 0 to 0.04, such as from 0 to 0.03, such as from 0 to 0.02, such as from 0 to 0.01, such as 0.

D′ is a dopant and it is clear that when z is 0, D′ is not present. D′ may be a dopant selected from B, N, F, Mg, Al, Nb, Si, P, La, S, Ca, Ti, Cr, Fe, Co, Cu, Zn, Zr, Mo, Sn, W and mixtures thereof. In one aspect, D′ is selected from the group consisting of B, Mg, Al, Nb, Si, P, La, S, Ti, Fe, Co, Cu, Zn, Zr, Mo, Sn, W and mixtures thereof.

As noted herein, the second crystal particles of the present invention comprise material having a spinel structure and of the formula Li_{x′}Ni_{y′}Mn_{3-x′-y′-z′}D′_{z′}O₄. In one aspect the second crystal particles comprise material having a spinel structure and which is of the formula Li_{x′}Ni_{y′}Mn_{3-x′-y′-z′}D′_{z′}O₄, in an amount of at least 50 wt. % based on the weight of the second crystal particles, such as in an amount of at least 55 wt. %, such as in an amount of at least 60 wt. %, such as in an amount of at least 60 wt. %, such as in an amount of at least 65 wt. %, such as in an amount of at least 70 wt. %, such as in an amount of at least 75 wt. %, such as in an amount of at least 80 wt. %, such as in an amount of at least 85 wt. %, such as in an amount of at least 90 wt. %, such as in an amount of at least 92 wt. %, such as in an amount of at least 94 wt. %, such as in an amount of at least 96 wt. %, such as in an amount of at least 98 wt. %, such as in an amount of at least 99 wt. %, such as in an amount of at least 99.5 wt. % based on the weight of the second crystal particles.

### Positive Electrode Active Material

As discussed herein, in one aspect there is provided a cathode active material comprising two types of lithium transition metal oxide particles having the general formula LiₓNi_{y}Mn_{3-x-y}O₄ and further comprising an optional dopant (D). The lithium transition metal oxides may have a spinel crystal structure. The cathode active material comprises:
(i) particles formed from one or more single crystals, wherein the arithmetic mean value of the minimum Feret diameter of the particles measured using scanning electron microscopy is no greater than 3 μm, and 0.95≤x≤1.05; and 0.45≤y≤0.50
(ii) secondary particles that may be formed from agglomerated single crystal particles and 0.9≤x≤1.05; 0.43≤y<0.47.

In one aspect, the first crystal particles have a particle size of from 0.5 to 2 μm measured as the arithmetic mean value of the minimum Feret diameter of the particles measured using scanning electron microscopy; and the second crystal particles have an average particle size of from 5 to 10 μm, measured as the arithmetic mean value of the minimum Feret diameter of the particles measured using scanning electron microscopy.

In one aspect, the first crystal particles have a particle size of no greater than 1 μm measured as the arithmetic mean value of the minimum Feret diameter of the particles measured using scanning electron microscopy; and the second crystal particles have an average particle size of at least 3 μm, measured as the arithmetic mean value of the minimum Feret diameter of the particles measured using scanning electron microscopy.

In an embodiment, the secondary particles of the cathode active material have a porosity of less than 8%, such as a porosity of less than 6%, such as a porosity of less than 4%, such as a porosity of from 1 to 3%. As will be understood by one skilled in the art, one may determine porosity by measuring the particle density with a pychnometer using ethanol. The porosity of the material is equal to 1−(particle density/skeletal density). As a reference the skeletal density of LNMO is 4.43 g/cm³.

In one aspect the first crystal particles are present in an amount of 20 to 80 wt. %, such as in an amount of 30 to 80 wt. %, such as in an amount of 30 to 70 wt. %, such as in an amount of 35 to 70 wt. % such as in an amount of 35 to 65 wt. % such as in an amount of 35 to 60 wt. % such as in an amount of 35 to 55 wt. %, such as in an amount of 35 to 50 wt. %, based on the weight of the cathode active material.

In one aspect the second crystal particles are present in an amount of 20 to 80 wt. %, such as in an amount of 30 to 80 wt. %, such as in an amount of 30 to 70 wt. %, such as in an amount of 35 to 70 wt. % such as in an amount of 35 to 65 wt. % such as in an amount of 35 to 60 wt. % such as in an amount of 35 to 55 wt. %, such as in an amount of 35 to 50 wt. %, based on the weight of the cathode active material.

### Process

The materials of the present invention may be prepared by two distinct processes which form the first crystal particles and the second crystal particles, and the first crystal particles and the second crystal particles may then be combined.

In a first process, it is provided the preparation of one or more single crystals of the first component, comprising the steps of
(i) providing one or more lithium precursor compounds and one or more transition metal precursor compounds,
(ii) contacting and milling the precursor compounds to form a milled mixture;
(iii) calcining the milled mixture to provide a calcined mixture;

The lithium precursor compounds of the first process may be are selected from Li₂CO₃ or LiOH·H₂O

The transition metal precursor compounds of the first process may be selected from any oxides of Mn and Ni, carbonates of Mn and Ni, and hydroxides of Mn and Ni. In one aspect the transition metal precursor compounds of the first process are selected from MnO₂, Mn₃O₄, MnCO₃, NiCO₃, and basic Ni-carbonates such as (Ni(CO₃)x(OH)y·zH₂O where (2x+y=2)), and mixtures thereof.

In one aspect the milled mixture is calcined at a temperature of at least 800° C. In embodiments of the process, the milled mixture is calcined at a temperature of from 300 to 1200° C., such as from 400 to 1100° C., such as from 500 to 1100° C., such as from 500 to 1000° C., such as from 600 to 1000° C., such as from 700 to 950° C.

The milled mixture may be calcined for any suitable period. In one aspect, the milled mixture is calcined for a period of a least 10 minutes, such as at least 30 minutes, such as least 1 hour, such as least 2 hours, such as least 3 hours. In one aspect, the milled mixture is calcined for a period of from 10 minutes to 10 hours, such as from 30 minutes to 10 hours, such as from 1 hour to 10 hours, such as 2 hours to 10 hours, such as 3 hours to 10 hours.

After the milled mixture is calcined it is typically cooled. “Cooled” means treating a material at a temperature or temperature range that is gradually lowered in order to reduce the temperature of the material. Typical cooling conditions are cooling at between 1° C. and 5° C. per minute when lowering the temperature from 900° C. to 700° C. Optionally, the material may be cooled to, for example, 600° C., 500° C., 400° C., 300° C., 200° C., 100° C., 50° C., room temperature (i.e. about 25° C.).

The second process is for preparing the second crystal particles of the positive electrode active material. The process comprises the steps of
(i) providing one or more transition metal compounds,
(ii) precipitating the transition metals to form a precipitate, and washing the precipitate to form a first precursor mixture;
(iii) contacting the first precursor mixture with a one or more lithium precursor compounds to form a second precursor mixture, and
(iv) calcining the second precursor mixture.

As will be appreciated by one skilled in the art, step (ii) results in the formation of waste water from the washing.

The lithium precursor compounds may be selected from Li₂CO₃, LiOH·H₂O, and LiNO₃ and mixtures thereof.

The transition metal precursor compounds of the second process may be selected from compounds of Ni and Mn that may be dissolved in water. In one aspect the transition metal precursor compounds are be selected from MnSO₄, Mn(NO₃)₂, NiSO₄, Ni(NO₃)₂ and mixtures thereof.

In one aspect the second precursor mixture is dried before step (iv), namely calcining the second precursor mixture.

In one aspect the second precursor mixture is calcined in a reducing atmosphere at a temperature of at least 500° C. and then calcined in air at a temperature of at least 800° C.

In embodiments of the process, the second precursor mixture is calcined at a temperature of from 300 to 1200° C., such as from 400 to 1100° C., such as from 500 to 1100° C., such as from 500 to 1000° C., such as from 600 to 1000° C., such as from 700 to 900° C.

The second precursor mixture may be calcined for any suitable period. In one aspect, the second precursor mixture is calcined for a period of a least 10 minutes, such as at least 30 minutes, such as least 1 hour, such as least 2 hours, such as least 3 hours, such as least 4 hours, such as least 5 hours, such as least 6 hours, such as least 7 hours, such as least 8 hours, such as least 9 hours, such as least 10 hours. In one aspect, the second precursor mixture is calcined for a period of from 10 minutes to 20 hours, such as from 30 minutes to 20 hours, such as least 1 hour to 20 hours, such as least 2 hours to 20 hours, such as least 3 hours to 20 hours, such as least 4 hours to 20 hours, such as least 5 hours to 20 hours, such as least 6 hours to 20 hours, such as least 7 hours to 20 hours, such as least 8 hours to 20 hours, such as least 9 hours to 20 hours, such as least 10 hours to 20 hours.

After the second precursor mixture is calcined it is typically cooled. “Cooled” means treating a material at a temperature or temperature range that is gradually lowered in order to reduce the temperature of the material. Typical cooling conditions are cooling at between 1° C. and 5° C. per minute when lowering the temperature from 900° C. to 700° C. Optionally, the material may be cooled to, for example, 600° C., 500° C., 400° C., 300° C., 200° C., 100° C., 50° C., room temperature (i.e. about 25° C.).

In an embodiment, the intermediate further comprises up to 3 mol % other elements than Li, Ni, Mn and O. This is characterized in the formula of the patent as element D and D′, and such elements may for example be one or more of the following: B, N, F, Mg, Al, Si, P, S, Ca, Ti, Cr, Fe, Co, Cu, Zn, Zr, Mo, Sn, W, any mixture thereof or any chemical composition containing one or more of these compounds. The dopants may originate from addition or from impurities in starting materials.

“Precursor” means a composition prepared by processes like mechanically mixing and co-precipitation, before heat treatment at temperatures like 300° C.-1000° C.

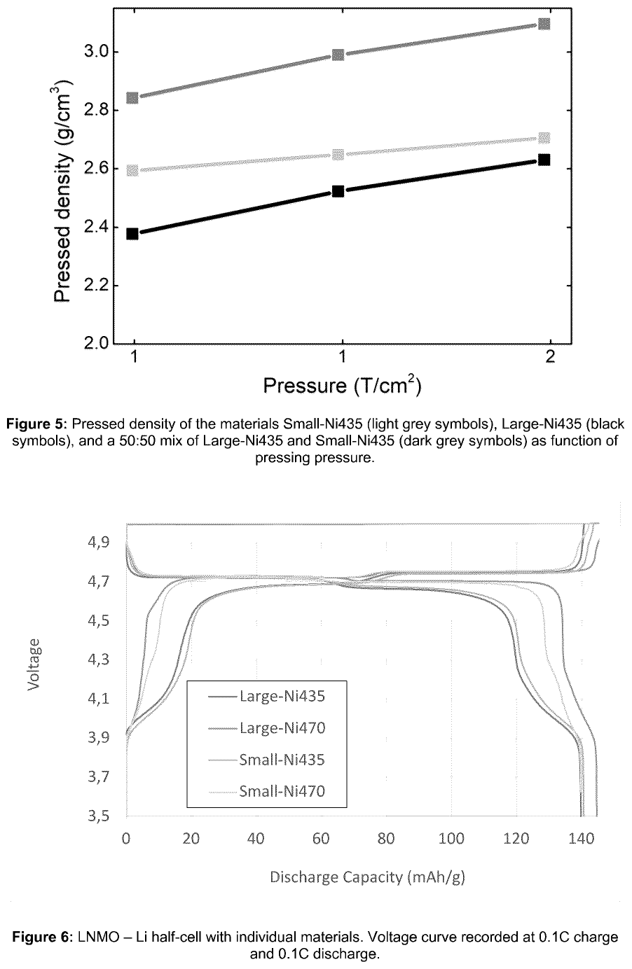

“Pressed density” is the chosen measurement in the present application related to definition of the powder density. A powder can be compacted or loosened into a vastly larger range of bulk densities than can a coarser granular material. When vibrated or compressed it may become very dense and even lose its ability to flow. The measurement of “pressed density” of the cathode active material powders in the present invention is described in Example 7 and results are shown in FIG. 5 and in Tables 1-3.

“Reducing atmosphere” means an atmosphere that shifts the thermodynamic equilibrium of the solid towards a distribution of phases with an average oxidation state of the metals lower than in the Spinel phase at the relevant heat treatment temperature. The reducing atmosphere may be provided by the type of gas present within the reaction vessel during heating. This gas may be provided by the presence of a reducing gas; for example, the reducing gas may be one or more gases selected from the group of: hydrogen; carbon monoxide; carbon dioxide; nitrogen; less than 15 vol % oxygen in an inert gas; and mixtures thereof. The term “less than 15 vol % oxygen in an inert gas” is meant to cover the range from 0 vol % oxygen, corresponding to an inert gas without oxygen, up to 15 vol % oxygen in an inert gas. Preferably, the amount of oxygen in the reducing atmosphere is low, such as below 1000 ppm and most preferably below 10 ppm. Typically, oxygen would not be added to the atmosphere; however, oxygen may be formed during the heating.

“Inert gas” means a gas that does not participate in the process. Examples of inert gasses comprise one or more gases selected from the group of: argon; nitrogen; helium; and mixtures thereof.

Additionally, the term “reducing atmosphere” is meant to comprise a composition comprising two or more gases, wherein one gas is considered a non-reducing atmosphere gas when used independently of other gasses, and a second gas or substance that decreases the oxidising potential of the gas mixture. The total reducing ability of the atmosphere corresponds to a reducing atmosphere. Such a composition may be selected from the group comprising: nitrogen, less than 15 vol % oxygen in an inert gas, air and hydrogen; air and CO; air and methanol; air and carbon dioxide.

Additionally, a “reducing atmosphere” may be obtained by adding a substance to the precursor composition or by adding a gaseous composition to the atmosphere in order to remove all or part of any oxidising species present in the atmosphere of the reaction vessel during heating. The substance may be added to the precursor either during the preparation of the precursor or prior to heat treatment. The substance may be any material that can be oxidised and preferably comprising carbon, for example, the substance may be one or more compounds selected from the group consisting of graphite, acetic acid, carbon black, oxalic acid, wooden fibres and plastic materials.

“Non-reducing atmosphere” means an atmosphere that shifts the thermodynamic equilibrium of the solid fully towards the Spinel phase when the temperature is below 700° C.

In an embodiment, the non-reducing atmosphere is a gaseous composition selected from the group consisting of air, and a composition comprising at least 5 vol % oxygen in an inert gas. The non-reducing atmosphere may be provided by the type of gas present within the reaction vessel during heating. Preferably, the non-reducing gas is air.

“Calcining” means treating a material at a temperature or temperature range in order to obtain the desired crystallinity. The temperature or temperature range is intended to represent the temperature of the material being heat treated. Typical calcination temperatures are about 500° C., about 600° C., about 700° C., about 800° C., about 900° C., about 1000° C. and temperature ranges are from about 300° C. to about 1200° C.; from about 500° C. to about 1000° C.; from 650° C. to 950° C. The term “calcination at a temperature of between X and Y ° C.” is not meant to be limiting to one specific temperature between X and Y; instead, the term also encompasses calcination to a range of temperatures within the temperature span from X to Y during the time of the heating.

In another aspect the present invention provides a process for the preparation of a cathode active material as described herein, comprising:
A. the preparation of one or more single crystals of the first component, comprising the steps of:
(i) providing one or more lithium precursor compounds and one or more transition metal precursor compounds,
(ii) contacting and milling the precursor compounds to form a milled mixture;
(iii) calcining the milled mixture to provide a calcined mixture;
B. the preparation of the second crystal particles of the positive electrode active material comprising the steps of:
(i) providing one or more transition metal compounds,
(ii) precipitating the transition metals to form a precipitate, and washing the precipitate to form a first precursor mixture;
(iii) contacting the first precursor mixture with a one or more lithium precursor compounds to form a second precursor mixture, and
(iv) calcining the second precursor mixture.
C. combining the products obtained in A and B.

In the present process the products obtained in A and B may be combined in a slurry.

In the present process the products obtained in A and B may be combined in a ratio of from 30:70 to 70:70 by weight, such as in a ratio of from 40:60 to 60:40 by weight, such as in a ratio of 50:50 by weight.

The process of the present invention may comprise one or more further steps. These one or more further steps may be before, after, or intermediate to the steps recited herein.

In another aspect the present invention provides a cell comprising a cathode active material comprising:
(a) first crystal particles, wherein the first crystal particles have a spinel structure and are of the formula LiₓNi_{y}Mn_{3-x-y-z}D_{z}O₄, wherein 0.95≤x≤1.05; and 0.45≤y≤0.50, and 0≤z≤0.20, and wherein D is a dopant selected from B, N, F, Mg, Al, Nb, Si, P, La, S, Ca, Ti, Cr, Fe, Co, Cu, Zn, Zr, Mo, Sn, W and mixtures thereof, and the first crystal particles have a particle size of no greater than 3 μm measured as the arithmetic mean value of the minimum Feret diameter of the particles measured using scanning electron microscopy,
(b) second crystal particles, wherein the second crystal particles comprise material having a spinel structure and which is of the formula Li_{x′}Ni_{y′}Mn_{3-x′-y′-z′}D′_{z′}O₄, wherein: 0.95≤x′≤1.05; 0.43≤y′<0.47, and 0≤z≤0.20, and wherein D′ is a dopant selected from B, N, F, Mg, Al, Nb, Si, P, La, S, Ca, Ti, Cr, Fe, Co, Cu, Zn, Zr, Mo, Sn, W and mixtures thereof, and the second crystal particles have an average particle size of at least 3 times that of the average particle size of the first crystal particles, measured as the arithmetic mean value of the minimum Feret diameter of the particles measured using scanning electron microscopy, wherein y>y′.

### EXPERIMENTAL SECTION

In the following, exemplary and non-limiting embodiments of the invention are described in the form of experimental data. Examples 1-4 relate to methods of preparation of the cathode active material. Example 5 describes a method of measuring the minimum Feret diameter. Example 6 describes a method for obtaining an SEM image of the cross section of an electrode. Example 7 describes a method for determining the pressed density of a cathode active material. Example 8 refers to the electrochemical characterization. Example 9 describes the determination of Ni and Mn content in the spinel and example 10 presents some data and results for the claimed product and comparative data.

### Example 1—Synthesis of Cathode Active Material—Small-Ni435

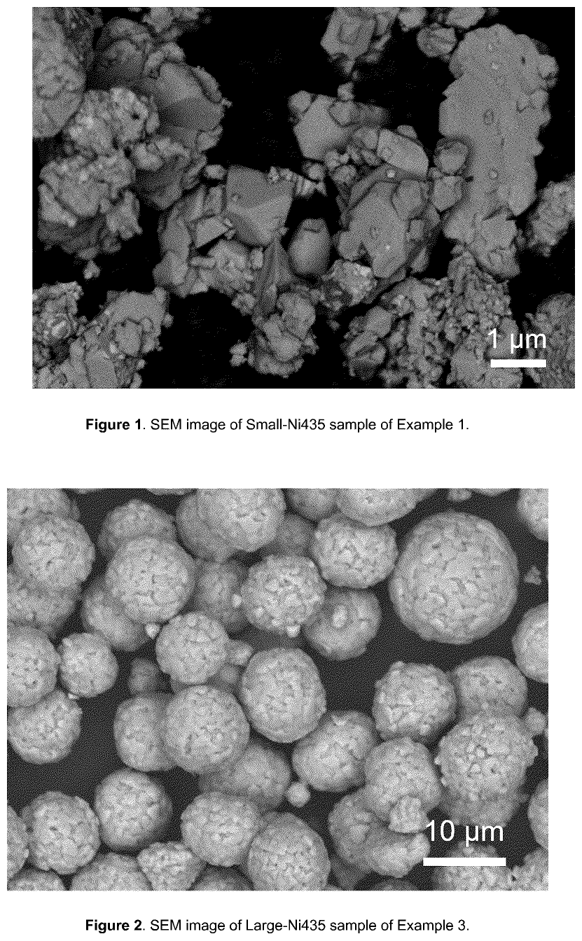

MnO₂ (269.5 g corresponding to 3.1 mol Mn), basic Ni(OH)ₓ(CO₃)_{y} (133 g corresponding to 0.9 mol Ni) and Li₂CO₃ (73.9 g corresponding to 2.0 mol Li) and 1 L water were weighed and ball-milled (600 rpm for 30 min minutes with reverse rotation) in a planetary ball mill in order to form a slurry with a molar ratio of Li:Ni:Mn=1.00:0.45:1.55. The mixture was then dried at 120° C. for 12 hours. The powder was then mixed in a mortar for 15 min minutes to obtain a precursor. 20 g of the precursor was heated in a 50 mL crucible for 3 hours at 900° C., followed by cooling of 1.5° C./min to room temperature. The product was broken down in a mortar for 15 minutes and passed through a 45-micron sieve resulting in cathode active material consisting of LNMO. A representative SEM image of the sample can be seen in FIG. 1. The arithmetic mean value of the minimum Feret diameter of the material is determined to be 0.66 μm as described in Example 5. Based on electrochemical characterization as described in Example 6, the stoichiometry of the obtained LNMO material is determined to be Li_{1.00}Ni_{0.435}Mn_{1.565}O₄. The sample is therefore referred to as Small-Ni435.

### Example 2—Synthesis of Cathode Active Material—Small-Ni470

MnO₂ (264.3 g corresponding to 3.04 mol Mn), basic Ni(OH)ₓ(CO₃)_{y} (141.9 g corresponding to 0.96 mol Ni) and Li₂CO₃ (73.9 g corresponding to 2.0 mol Li) and 1 L water were weighed and ball-milled (600 rpm for 30 min minutes with reverse rotation) in a planetary ball mill in order to form a slurry with a molar ratio of Li:Ni:Mn=1.00:0.48:1.52. The mixture was then dried at 120° C. for 12 hours. The powder was then mixed in a mortar for 15 minutes to obtain a precursor. 20 g of the precursor was heated in a 50 mL crucible for 3 hours at 900° C., followed by cooling of 0.5° C./min to room temperature. The product was broken down in a mortar for 15 min minutes and passed through a 45-micron sieve resulting in cathode active material consisting of LNMO. The particle morphology and particle size of the material is the same at the Small-Ni435 sample of Example 1. Based on electrochemical characterization as described in Example 6, the stoichiometry of the obtained LNMO material is determined to be Li_{1.00}Ni_{0.47}Mn_{1.53}O₄. The sample is therefore referred to as Small-Ni470.

### Example 3—Synthesis of Cathode Active Material—Large-Ni435

Co-precipitation of Ni,Mn-carbonate by mixing a solution of NiSO₄ and MnSO₄ corresponding to a molar ratio of Ni:Mn=0.45:1.55, combining the mix with Na₂CO₃ under stirring to form spherical particles of co-precipitated Ni,Mn-carbonate that is washed and dried to remove Na⁺ and SO₄²⁻ ions. Mixing 940 g of said co-precipitated Ni,Mn-carbonate particles with 150 g Li₂CO₃ (corresponding to Li:Ni:Mn=1.00:0.45:1.55) and ethanol to form a viscous slurry. The slurry is shaken in a paint shaker for 3 minutes to obtain full de-agglomeration and mixing of the particulate materials. The slurry is poured into trays and left to dry at 80° C. The dried material is further deagglomerated by shaking in a paint shaker for 1 minute to obtain a free-flowing homogeneous powder mix. The powder mix is heated in a furnace with nitrogen flow with a ramp of 2.5° C./min to 550° C. The powder is heated 10 hours at 550° C. Hereafter the powder is treated for 10 hours in air at 550° C. The temperature is increased to 950° C. with a ramp of 2.5° C./min. A temperature of 950° C. is maintained for 10 hours and decreased to room temperature with a ramp of 1.5° C./min.

The powder is again de-agglomerated by shaking for 6 minutes in a paint shaker and passed through a 45-micron sieve resulting in cathode active material consisting of LNMO. SEM image of the sample is shown in FIG. 2. The arithmetic mean value of the minimum Feret diameter of the material is 8 μm. Based on electrochemical characterization as described in Example 6, the stoichiometry of the obtained LNMO material is determined to be Li_{1.00}Ni_{0.435}Mn_{1.565}O₄. The sample is therefore referred to as Large-Ni435.

### Example 4—Synthesis of Cathode Active Material

Co-precipitation of Ni,Mn-carbonate by mixing a solution of NiSO₄ and MnSO₄ corresponding to a molar ratio of Ni:Mn=0.48:1.52, combining the mix with Na₂CO₃ under stirring to form spherical particles of co-precipitated Ni,Mn-carbonate that is washed and dried to remove Na⁺ and SO₄²⁻ ions. Mixing 940.5 g of said co-precipitated Ni,Mn-carbonate particles with 150 g Li₂CO₃ (corresponding to Li:Ni:Mn=1.00:0.48:1.52) and ethanol to form a viscous slurry. The slurry is shaken in a paint shaker for 3 minutes to obtain full de-agglomeration and mixing of the particulate materials. The slurry is poured into trays and left to dry at 80° C. The dried material is further deagglomerated by shaking in a paint shaker for 1 minute to obtain a free-flowing homogeneous powder mix. The powder mix is heated in a furnace with nitrogen flow with a ramp of 2.5° C./min to 550° C. The powder is heated 10 hours at 550° C. Hereafter the powder is treated for 10 hours in air at 550° C. The temperature is increased to 950° C. with a ramp of 2.5° C./min. A temperature of 950° C. is maintained for 10 hours and decreased to room temperature with a ramp of 0.5° C./min.

The powder is again de-agglomerated by shaking for 6 minutes min in a paint shaker and passed through a 45-micron sieve resulting in cathode active material consisting of LNMO. The particle morphology and particle size of the material is the same at the Large-Ni435 sample of Example 3. Based on electrochemical characterization as described in Example 6, the stoichiometry of the obtained LNMO material is determined to be Li_{1.00}Ni_{0.47}Mn_{1.53}O₄. The sample is therefore referred to as Large-Ni470.

### Example 5—Material Characterization

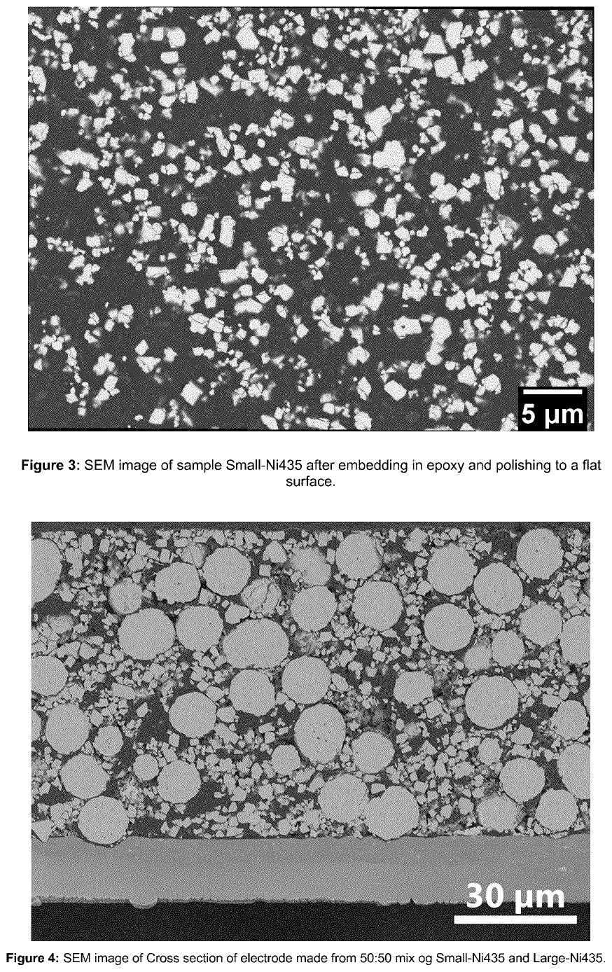

The material is embedded in epoxy and polished to a flat surface. SEM images are acquired on a Zeiss Gemini SEM 500, equipped with a field emission gun (FEG) an FEG, using an acceleration voltage of 10 kV and the energy selective backscattered (ESB) ESB detector, which is of the backscatter electron detector type. The pixel size is 0.01 μm/pixel. A total number of 25 images are acquired and stitched to a high-resolution image of 4930 pixels by 3697 pixels corresponding to an image area of 48 μm*36 μm. The image of Small-Ni435 produced as described in Example 1 is shown in FIG. 3. The image is analysed according to the procedure below, detecting and analysing a total number of 663 particles

Images are analysed using the software ImageJ (https://imagej.nih.gov). The procedure is:
Thresholding and segmentation using “Otsu's algorithm”
Apply the binary process, “Fill holes”
Apply the binary process, “Erode” 8 times
Apply the binary process, “Dilate” 6 times.
Use “Analyze particles” with no size restriction

Fill holes is used to fill possible holes inside particles. The Erode then dilate step is used to remove possible noise and ensure that close laying particle are separated.

### Result of the Size Measurement:

Average minimum Feret 0.66 μm
Average equivalent circle diameter 0.84 μm
Number of particles 663

### Example 6—Characterisation of Electrode of Mixed Material

A SEM image of an electrode cross section with Mix1 (Small-Ni435 and Large-Ni435) is shown in FIG. 4. The cross section of the pressed electrode is prepared by embedding in epoxy and polishing to a flat surface perpendicular to the electrode surface.

### Example 7—Pressed Density

The pressed density of the cathode active material powders is measure in the following way. 3.00 g of material is loaded into a die with a cylindrical whole (16 mm diameter). By applying a pressure (1-2 ton/cm2) onto a punch that fits the whole in the die the power is compacted. By measuring the position of the punch the volume of the powder can be determined and thus the pressed density. The pressed density as function of applied pressure for the materials in Example 1, Example 2 and a 50:50 mixture of these two materials is shown in FIG. 5 and in Tables 1-3.

### Example 8—Electrochemical Characterization

Electrochemical tests have been realized in 2032 type coin cells, using thin composite positive electrodes and negative electrodes of metallic lithium (half cells) and lithium-titanium-oxide (LTO) (full cells), respectively. The thin composite positive electrodes were prepared by thoroughly mixing 92 wt % of cathode active LNMO material with 4 wt % Super C65 carbon black (Timcal) and 4 wt % PVdF binder (polyvinylidene difluoride, Arkema) in NMP (N-methyl-pyrrolidone) to form a slurry. The slurries were spread onto carbon coated aluminium foils using a doctor blade with a 100-200 μm gap and dried for 12 hours at 80° C. to form films. Electrodes with a diameter of 14 mm and a loading of approximately 12 mg of cathode active material were cut from the dried films, pressed in a hydraulic pellet press (diameter 20 mm; 3 tonnes) and subjected to 10 hours drying at 120° C. under vacuum in an argon filled glove box. LTO electrodes were acquired from Custom Cells Itzehoe gmbh. Coin cells were assembled in argon filled glove box (<1 ppm O2 and H2O) using a glass fibre separator, an electrolyte containing 1 molar LiPF₆ in EC:DEC (1:1 in weight) and a 500 μm thick lithium disk as anode electrodes in the case of half cells and Celgard H2010 separator, an electrolyte containing 1 molar LiPF₆ in EC:DEC (1:1 in weight) and a 15 mm diameter LTO electrode with a loading corresponding to a balancing N/P of 1.2 (in the case of full cells.

Electrochemical lithium insertion and extraction were monitored with an automatic cycling data recording system (Maccor) operating in galvanostatic mode. The (dis)charging current is given in the units of C. The definition of 1 C is the theoretical current required to (dis)charge the cell in 1 hour.

The electrochemical test of half-cells contains 4 formation cycles (1 cycle 0.2 C/0.2 C (charge/discharge), 1 cycle 0.5 C/0.5 C and 2 cycles 0.5 C/1 C)0.5 C/0.2 C), 9 power test cycles (3 cycles 0.5 C/1 C, 3 cycles 0.5 C/5 C, 3 cycles 0.5 C/10 C), followed by one 0.1 C/0.1 C cycle to measure capacity and then 50 0.5 C/1 C cycles to measure degradation.

The electrochemical test of full cells contains 3 formation cycles at 0.1 C/0.1 C to measure the cell capacity.

The half-cells are cycled in the voltage interval 3.5-5.0 V, which mean that the upper cut-off voltage for charge is 5.0 V and the lower cut-off voltage for discharge is 3.5 V.

LNMO-LTO cells are cycled in the voltage intervals 1.7-3.4 V and 2.8-3.4 V.

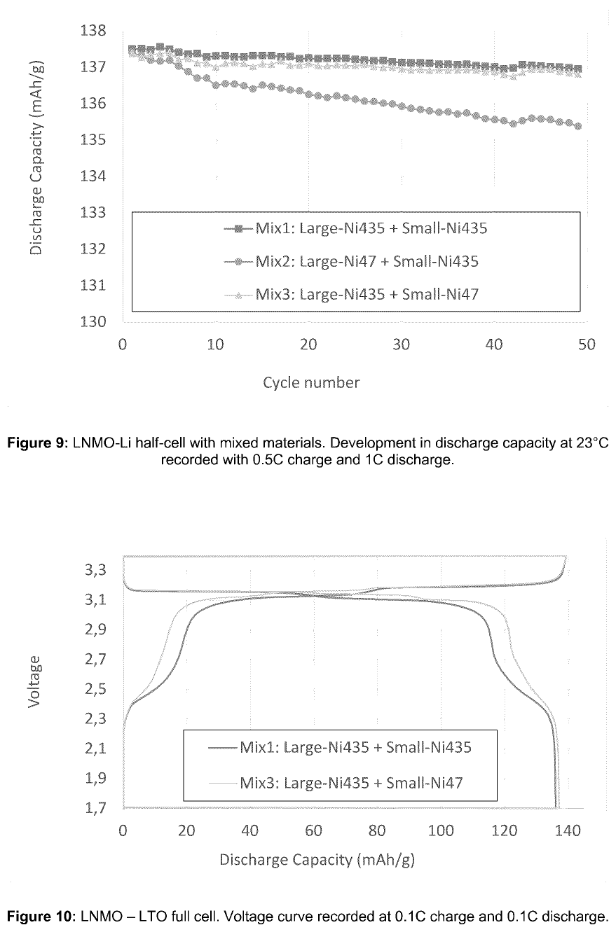

The LNMO materials tested and presented in FIGS. 6-11 are small particles prepared according to Examples 1 (Small-Ni435) and 2 (Small-Ni470) and large particles prepared according to Examples 3 (Large-Ni435) and 4 (Large-Ni470) and mixtures of these, where the number refer to the nickel content in the spinel material determined by electrochemical characterization as described in Example 9.

When testing mixtures, both LNMO materials are added to the slurry at the same time, in a ratio of 50:50 by weight. Tests of three material mixes are presented. These are Large-Ni435+Small-Ni435 (Mix 1), Large-Ni470+Small-Ni435 (Mix 2) and Large-Ni435+Small-Ni470 (Mix3).

The LNMO materials tested and presented in FIG. 12 are synthesized as described in Examples 1 and 3, but with small modifications in the recipe to achieve different nickel content in the spinel.

Capacity is given relative to the LNMO content in the electrode as the charge accumulated during discharge from the upper voltage limit to the lower voltage limit. The unit for capacity is mAh/(g LNMO).

Degradation of the cell is given as relative loss of capacity after 100 charge and discharge cycles. The unit for degradation is %/100 cycles.

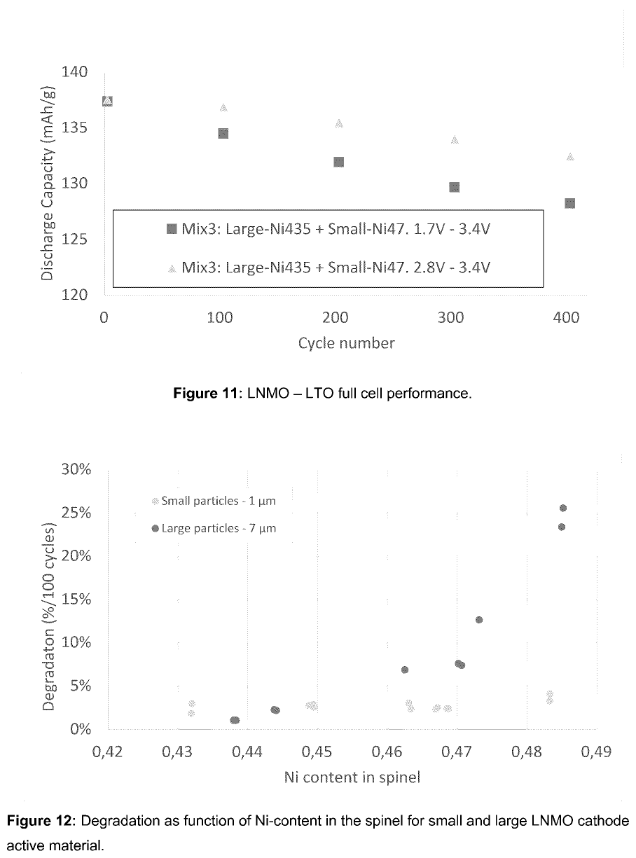

Electrochemical data for half-cells are shown in FIGS. 6-9 and 12, and data for LNMO-LTO cells are shown in FIGS. 10-11.

The voltage curves illustrated in FIGS. 6, 8 and 10 are collected by the battery tester and used to calculate the capacity and average voltage.

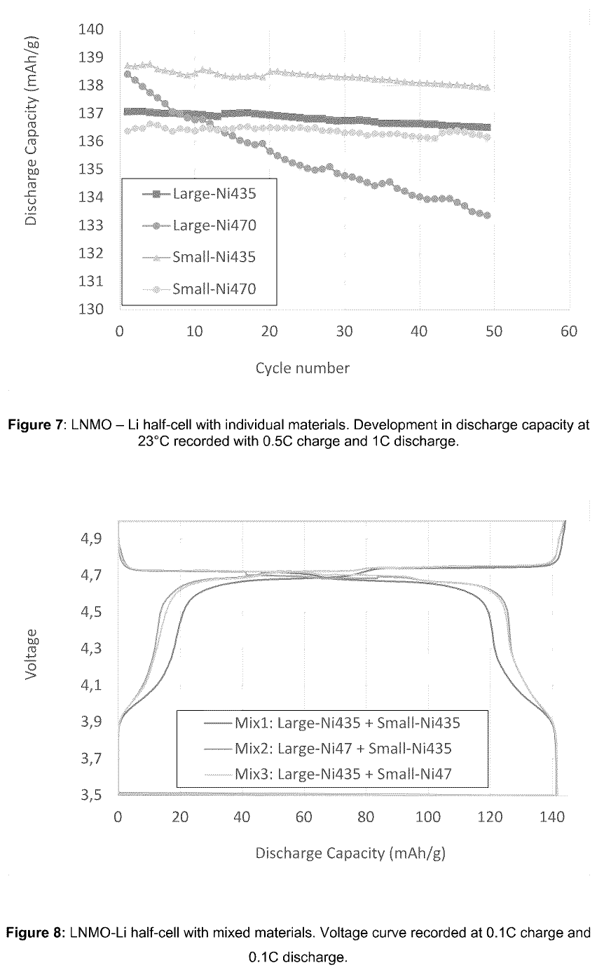

In FIGS. 7, 9, and 11 the capacities as function of charge-discharge cycle are plotted. These data are used to determine the degradation of the cells.

The calculated degradation is shown in FIG. 12 for a number of samples with different particle size and different content of nickel in the spinel.

Specific energy density of the cathode active material in the cells is determined by multiplying average voltage and capacity.

Energy density of the cathode active material in the cells is determined by multiplying specific energy density with the pressed density. Determination of pressed density is described in Example 7.

Capacities, average voltages, degradation, and energy densities are summarized in Tables 1-4.

### Example 9—Determination of the Ni and Mn Content in the Spinel

Depending on the preparation of the lithium positive electrode active material, the content of Ni and Mn in the spinel of the lithium positive electrode active material may be different from the bulk values that can be determined using ICP among others. This example demonstrates that the Ni and Mn content in the spinel of the lithium positive electrode active material may be determined using two different methods based on electrochemistry and diffraction, respectively.

The methods exploit that variations in the Mn/Ni ratio change the ratio between Mn³⁺ and Mn⁴⁺. This is apparent by calculating the average oxidation state of Mn in LiₓNi_{y}Mn_{2-y}O₄ as (4*2−1*x−2*y)/(2−y) based on the assumption that the oxidation state of Li is 1+, Ni is 2+ and O is −2. Using this, the formula can be written as Li⁺¹Ni⁺²_{y}Mn⁺³_{1-2y}Mn⁺⁴_{1+y}O₄ in the case of x=1, and a similar expression for x different from 1.

Electrochemically, Mn³⁺ can be oxidized reversibly to Mn⁴⁺ and back by extraction and insertion of Li⁺ during cycling, and Ni²⁺ can be oxidized reversibly to Ni⁴⁺ and back by extraction and insertion of Li⁺ during cycling. It is thus possible to extract (and subsequently insert) two Li⁺ per Ni²⁺ and one Li⁺ per Mn³⁺. Based on the formula Li⁺¹Ni⁺²_{y}Mn⁺³_{1-2y}Mn⁺⁴_{1+y}O₄ in the case of x=1, the share of capacity related to Mn activity compared to the total capacity is thus given by (1−2y)/(1−2y+2y)=(1−2y). As an example, y=0 corresponds to 0% capacity related to Mn activity and y=0.45 and 0.4 corresponds to 10% and 20% of the total capacity coming from Mn activity, respectively.

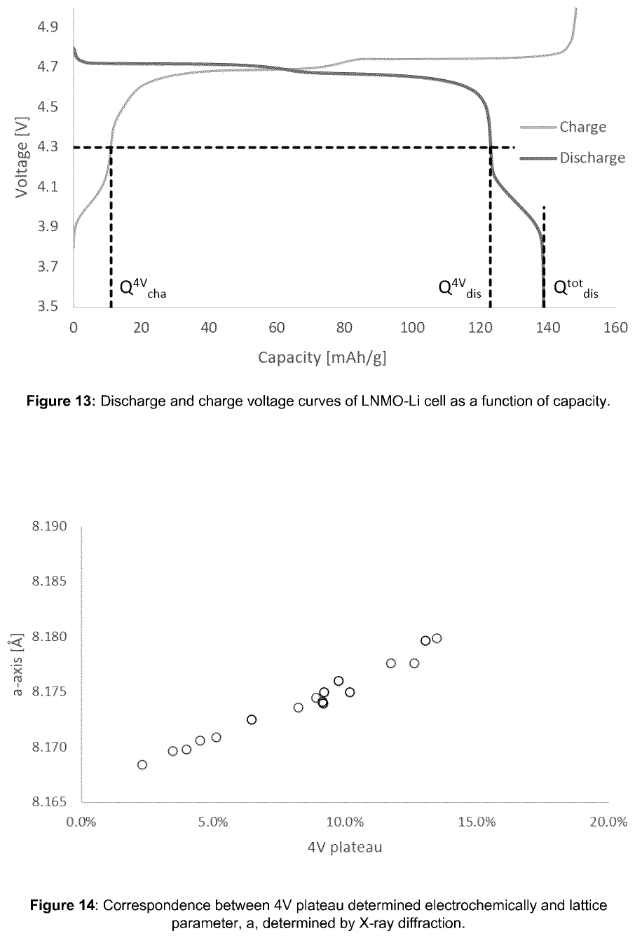

In LNMO, Mn³⁺/Mn⁴⁺ reactions are observed around 4 V vs. Li/Li⁺ and Ni²⁺/Ni⁴⁺ reactions are observed around 4.7 V vs. Li/Li⁺. It is therefore expected that the capacity measured between 3.5 V and 4.3 V vs. Li/Li⁺ compared to the total capacity between 3.5 V and 5 V vs. Li/Li⁺ corresponds to Mn activity. The capacity around 4V is determined using the second discharge with a current of 74 mA/g (0.5 C) as described in Example 8. During charge and discharge, the cell is not in equilibrium and the measured voltages may shift upwards during charge and downwards during discharge due to internal resistance in the cell. This effect is especially pronounced near sudden changes in cell voltage and the fraction of Mn-activity will therefore appear different depending on whether the analysis is based on a charge or a discharge. The true value will be between these two values and a reasonable estimate is the average between the two. FIG. 13 shows the discharge and charge voltage curves as a function of capacity for the second charge and discharge with a current of 74 mA/g (0.5 C) as described in Example 8. Using the capacities Q^{4V}_{cha} and Q^{4V}_{dis} corresponding to a voltage of 4.3 V during charge and discharge, respectively, and the total discharge capacity Q^{tot}_{dis}, the fraction of Mn-activity is given by (Q^{4V}_{cha}+(Q^{tot}_{dis}−Q^{4V}_{dis}))/(2*Q^{tot}_{dis}). This value is denoted “4V plateau”.

### Diffraction

The size of Mn³⁺ and Mn⁴⁺ ions are different, with Mn³⁺ being the largest, and this affect the lattice parameter of the spinel. Powder x-ray diffraction data were collected on a Phillips PW1800 instrument system in θ-2θ geometry working in Bragg-Brentano mode using Cu Kα radiation (λ=1.541 Å). The observed data needs to be corrected for experimental parameters contributing to shifts in the observed peak positions, which are used to calculate the lattice parameter. This is achieved using the full profile fundamental parameter approach as implemented in the TOPAS software from Bruker. As a result the spinel lattice parameter is determined with an uncertainty around 5/10000 Å, which is enough to determine the amount of Mn³⁺ and thus the amount of Mn and Ni.

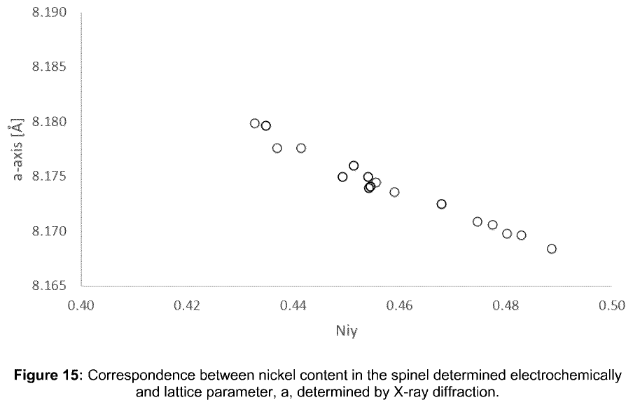

The validity of the two methods is shown by comparing the 4V plateau as determined electrochemically with the a-axis determined using XRD. FIG. 14 shows this comparison and the linear correlation directly link the increased volume to the increase in Mn³⁺. FIG. 15 show the same data as FIG. 14, but the x-axis is converted to the nickel content, y, of the spinel using that the 4V plateau is given by (1-2y) as described above. The relation between the a-axis determined using XRD measurements and the ratio between Mn and Ni given by y as determined from the 4V plateau can be fitted with the line: a=−0.1932*y+8.2627. The LNMO materials tested and presented in FIGS. 14 and 15 are synthesized as described in Examples 1 and 3, but with small modifications in the recipe to achieve different nickel content in the spinel.

The two methods have been further validated by comparing the measured nickel content of selected samples with direct measurement of Ni and Mn content inside the particles using scanning transmission electron microscopy—energy dispersive X-ray spectroscopy.

### Example 10—Comparison of Data

TABLE 1
Individual LNMO materials - half-cells

| | Large- | Large- | Small- | Small- |
|---|---|---|---|---|
| Material | Ni435 | Ni470 | Ni435 | Ni470 |
| Capacity 0.1 C (mAh/g) | 140 | 145 | 141 | 140 |
| Average voltage vs Li/Li⁺ (V) | 4.59 | 4.67 | 4.60 | 4.66 |
| Pressed density (g/cm³) | 2.5 | 2.5 | 2.6 | 2.6 |
| Degradation (%/100 cycles) | 0.8% | 7.4% | 1.1% | 0.3% |
| Voltage range 3.5 V-5.0 V | | | | |
| Specific energy density (Wh/g) | 0.64 | 0.68 | 0.65 | 0.65 |
| Energy density (Wh/cm³) | 1.60 | 1.69 | 1.68 | 1.70 |
| Voltage range 4.3 V-5.0 V | | | | |
| Specific energy density (Wh/g) | 0.56 | 0.63 | 0.57 | 0.61 |
| Energy density (Wh/cm³) | 1.40 | 1.59 | 1.48 | 1.59 |

TABLE 2
Mixed materials - half cells:

| | Mix1: | Mix2: | Mix3: |
|---|---|---|---|
| | Large-Ni435 + | Large-Ni470 + | Large-Ni435 + |
| Material | Small-Ni435 | Small-Ni435 | Small-Ni470 |
| Capacity 0.1 C (mAh/g) | 141 | 141 | 141 |
| Average voltage vs Li/Li⁺ (v) | 4.59 | 4.62 | 4.63 |
| Pressed density (g/cm³) | 3.0 | 3.0 | 3.0 |
| Degradation (%/100 cycles) | 0.9% | 4.1% | 0.9% |
| Voltage range 3.5 V-5.0 V | | | |
| Specific energy density (Wh/g) | 0.65 | 0.65 | 0.66 |
| Energy density (Wh/cm³) | 1.95 | 1.96 | 1.97 |
| Voltage range 4.3 V-5.0 V | | | |
| Specific energy density (Wh/g) | 0.57 | 0.60 | 0.59 |
| Energy density (Wh/cm³) | 1.71 | 1.79 | 1.78 |

TABLE 3
Mixed LNMO and high voltage anode (LTO)

| | | Mix1: | Mix3: |
|---|---|---|---|
| | | Large-Ni435 + | Large-Ni435 + |
| Material | Large-Ni435 | Small-Ni435 | Small-Ni470 |
| Pressed density, (g/cm³) | 2.5 | 3.0 | 3.0 |
| 1.7 V-3.4 V | | | |
| Capacity 0.1 C (mAh/g) | 136 | 136 | 137 |
| Average voltage (V) | 3.02 | 3.02 | 3.06 |
| Specific energy density (Wh/g) | 0.41 | 0.41 | 0.42 |
| Energy density (Wh/cm³) | 1.03 | 1.24 | 1.26 |
| Degradation (%/100 cycles) | | | 1.7% |
| 2.8 V-3.4 V | | | |
| Capacity 0.1 C (mAh/g) | 116 | 116 | 122 |
| Average voltage (V) | 3.13 | 3.13 | 3.14 |
| Specific energy density (Wh/g) | 0.36 | 0.36 | 0.38 |
| Energy density (Wh/cm³) | 0.91 | 1.09 | 1.15 |
| Degradation (%/100 cycles) | | | 0.9% |

TABLE 4
Comparison of key numbers on energy density
and degradation based on Tables 1-3

| | | Mix1: | Mix3: |
|---|---|---|---|
| | | Large-Ni435 + | Large-Ni435 + |
| Material | Large-Ni435 | Small-Ni435 | Small-Ni470 |
| LNMO in half cells (3.5 V-5.0 V) | | | |
| Energy density (Wh/cm³) | 1.6 | 1.95 | 1.97 |
| Relative energy density | 100% | 122% | 123% |
| LNMO-LTO cells (2.8 V-3.4 V) | | | |
| Energy density (Wh/cm³) | 0.91 | 1.09 | 1.15 |
| Relative energy density | 100% | 120% | 127% |

Several observations are highlighted based on Tables 1-4 and FIGS. 1-12 to clarify the optimum of high energy density and low degradation by varying particle size and nickel content of the LNMO spinel cathode active material:
Energy density can by maximized by increasing average voltage, specific capacity and powder density in the electrode.
   Average voltage is increased by increasing the nickel content in the spinel, e.g. 1.3% increase from 4.60 V to 4.66 V by changing nickel content in the spinel from y=0.435 to y=0.470 as seen in Table 1.
   Specific capacity is almost unchanged by nickel content of the spinel, but in some cases a limited voltage range is beneficial for degradation as seen in FIG. 11 and Table 3, and in this case, the specific capacity within this range increases with nickel content in the spinel, e.g. for LNMO-LTO cells, where specific capacity increases 5% from 116 mAh/g to 122 mAh/g in the range 2.8 V to 3.4 V by increasing nickel content in the small particles of a 50:50 mixture from y=0.435 to y=0.470 as seen in Table 3.
   Powder density is increased by mixing small and large particles, e.g. 20% increase from 2.5 g/cm³ to 3.0 g/cm³ by mixing small and large particles in 50:50 mixture compared to having large particles alone as seen by comparing Table 1 and Table 2.
Degradation increases with nickel content, but if the particles are small enough, degradation becomes independent of nickel content in the spinel. This is specifically seen in Tables 1 and 2, and in FIGS. 7, 9, 11 and 12.
The optimum is therefore a mix of small particles with a high nickel content and larger particles with lower nickel content. From the materials described in Examples 1-4, the optimal combination is a mixture of Large-Ni435 with Small-Ni470.

Table 4 show a comparison of how particle size and nickel content in the spinel affects the energy density. In general, energy density is improved around 20% by using a combination of small and large particles the surprising possibility to increase nickel content in small LNMO particles increases the energy density with additionally 1-6% depending on the battery cell chemistry and operation.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

1. A cathode active material comprising:
(a) first crystal particles, wherein the first crystal particles have a spinel structure and are of the formula LiₓNi_{y}Mn_{3-x-y-z}D_{z}O₄, wherein 0.95≤x≤1.05; and 0.45≤y≤0.50, and 0≤z≤0.20, and wherein D is a dopant selected from B, N, F, Mg, Al, Nb, Si, P, La, S, Ca, Ti, Cr, Fe, Co, Cu, Zn, Zr, Mo, Sn, W and mixtures thereof, and the first crystal particles have a particle size of no greater than 3 μm measured as the arithmetic mean value of the minimum Feret diameter of the particles measured using scanning electron microscopy,
(b) second crystal particles, wherein the second crystal particles comprise material having a spinel structure and which is of the formula Li_{x′}Ni_{y′}Mn_{3-x′-y′-z′}D′_{z′}O₄, wherein: 0.95≤x′≤1.05; 0.43≤y′<0.47, and 0≤z′≤0.20, and wherein D′ is a dopant selected from B, N, F, Mg, Al, Nb, Si, P, La, S, Ca, Ti, Cr, Fe, Co, Cu, Zn, Zr, Mo, Sn, W and mixtures thereof, and the second crystal particles have an average particle size of at least 3 times that of the average particle size of the first crystal particles, measured as the arithmetic mean value of the minimum Feret diameter of the particles measured using scanning electron microscopy, wherein y>y′.

2. Cathode active material, according to claim 1, wherein 0.98≤x≤1.02.

3. Cathode active material, according to claim 1, wherein x is 1.

4. Cathode active material, according to claim 1, wherein 0.46≤y≤0.50.

5. Cathode active material, according to claim 1, wherein 0.48≤y≤0.50.

6. Cathode active material, according to claim 1, wherein 0≤z≤0.05.

7. Cathode active material, according to claim 1, wherein D is a dopant selected from B, Mg, Al, Nb, Si, P, La, S, Ti, Fe, Co, Cu, Zn, Zr, Mo, Sn, W and mixtures thereof.

8. Cathode active material, according to claim 1, wherein z=0.

9. Cathode active material, according to claim 1, wherein the first crystal particles have a particle size of no greater than 2 μm.

10. Cathode active material, according to claim 1, wherein the second crystal particles are polycrystalline secondary particles.

11. Cathode active material, according to claim 1, wherein 0.98≤x′≤1.02.

12. Cathode active material, according to claim 1, wherein x′ is 1.

13. Cathode active material, according to claim 1, wherein 0.44≤y′<0.47.

14. Cathode active material, according to claim 1, wherein 0.45≤y′<0.46.

15. Cathode active material, according to claim 1, wherein 0≤z′≤0.05.

16. Cathode active material, according to claim 1, wherein D′ is a dopant selected from B, Mg, Al, Nb, Si, P, La, S, Ti, Fe, Co, Cu, Zn, Zr, Mo, Sn, W and mixtures thereof.

17. Cathode active material, according claim 1, wherein z′=0.

18. Cathode active material, according to claim 1, wherein the first crystal particles have a particle size of from 0.5 to 2 μm measured as the arithmetic mean value of the minimum Feret diameter of the particles measured using scanning electron microscopy; and the second crystal particles have an average particle size of from 5 to 10 μm, measured as the arithmetic mean value of the minimum Feret diameter of the particles measured using scanning electron microscopy.

19. Cathode active material, according to claim 1, wherein the first crystal particles have a particle size of no greater than 1 μm measured as the arithmetic mean value of the minimum Feret diameter of the particles measured using scanning electron microscopy; and the second crystal particles have an average particle size of at least 3 μm, measured as the arithmetic mean value of the minimum Feret diameter of the particles measured using scanning electron microscopy.

20. Cathode active material, according to claim 1, wherein the first crystal particles are single crystal particles.

21. Cathode active material, according to claim 1, wherein the second crystal particles comprise material having a spinel structure and which is of the formula Li_{x′}Ni_{y′}Mn_{3-x′-y′-z′}D′_{z′}O₄, in an amount of at least 94 wt. % based on the weight of the second crystal particles.

22. A cell comprising a cathode active material as defined in claim 1.
